(19) United States
(12) Patent Application Publication
(10) Pub. No.: US 2010/0251204 A1
(43) Pub. Date: Sep. 30, 2010

(54) System and method for determining software test cycle effectiveness

(76) Inventors: Michael Peterson, El Dorado, KS (US); John Lara, Wichita, KS (US)

Correspondence Address: LSI Corporation c/o Suiter Swantz pc llo, 14301 FNB Parkway, Suite 220, Omaha, NE, 68154, US

(21) Appl. No.: 12/383,882

(22) Filed: Mar. 30, 2009

(51) Int. Cl. G06F 9/44

(52) U.S. Cl. 717/102

(57) ABSTRACT

A method may include calculating a cost for software testing for a first software test cycle. The software testing is for producing a first software product. The method may also include calculating an income for the first software product. Additionally, the method may include calculating an effectiveness rating for the first software test cycle utilizing the cost of software testing and the income generated by the first software product.

### TECHNICAL FIELD

The present disclosure generally relates to the field of software testing, and more particularly to a system and method for determining software test cycle effectiveness.

### BACKGROUND

One of the problems that is currently encountered in software testing is the difficult nature of quantifying how effective software testing is for a given software product. Some techniques for trying to quantify the effectiveness of software testing have included utilizing raw, empirical numbers, such as the number of problems discovered during testing, or a number of test cases executed. Other techniques analyze how long testing took and/or how many defects were found after testing was completed. However, these techniques do not offer a comprehensive picture of how effective testing was for a particular software product. Moreover, raw numbers such as number of test cases and number of defects may be hard to compare, as the values for these measurements may differ based on how they are defined during different test cycles.

### SUMMARY

A method may include calculating a cost for software testing for a first software test cycle. The software testing is for producing a first software product. The method may also include calculating an income for the first software product. Additionally, the method may include calculating an effectiveness rating for the first software test cycle utilizing the cost of software testing and the income generated by the first software product.

A computer program product may include a signal bearing medium bearing one or more instructions for calculating a cost for software testing for a first software test cycle. The software testing is for producing a first software product. The signal bearing medium may also bear one or more instructions for calculating an income for the first software product. Additionally, the signal bearing medium may bear one or more instructions for calculating an effectiveness rating for the first software test cycle utilizing the cost of software testing and the income generated by the first software product.

A method may include transforming a first software product from an initial configuration to a final configuration during a first software test cycle. The method may also include calculating a cost for software testing for the first software test cycle. Additionally, the method may include calculating an income for the first software product. Further, the method may include calculating an effectiveness rating for the first software test cycle utilizing the cost of software testing and the income generated by the first software product.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for determining software test cycle effectiveness in accordance with the present disclosure;

FIG. 2 illustrates a computer program product in accordance with the present disclosure;

FIG. 3 is a process flow diagram illustrating a method for utilizing the computer program product illustrated in FIG. 2; and

FIG. 4 illustrates a system in accordance with the present disclosure.

### DETAILED DESCRIPTION

Reference will now be made in detail to the subject matter disclosed, which is illustrated in the accompanying drawings.

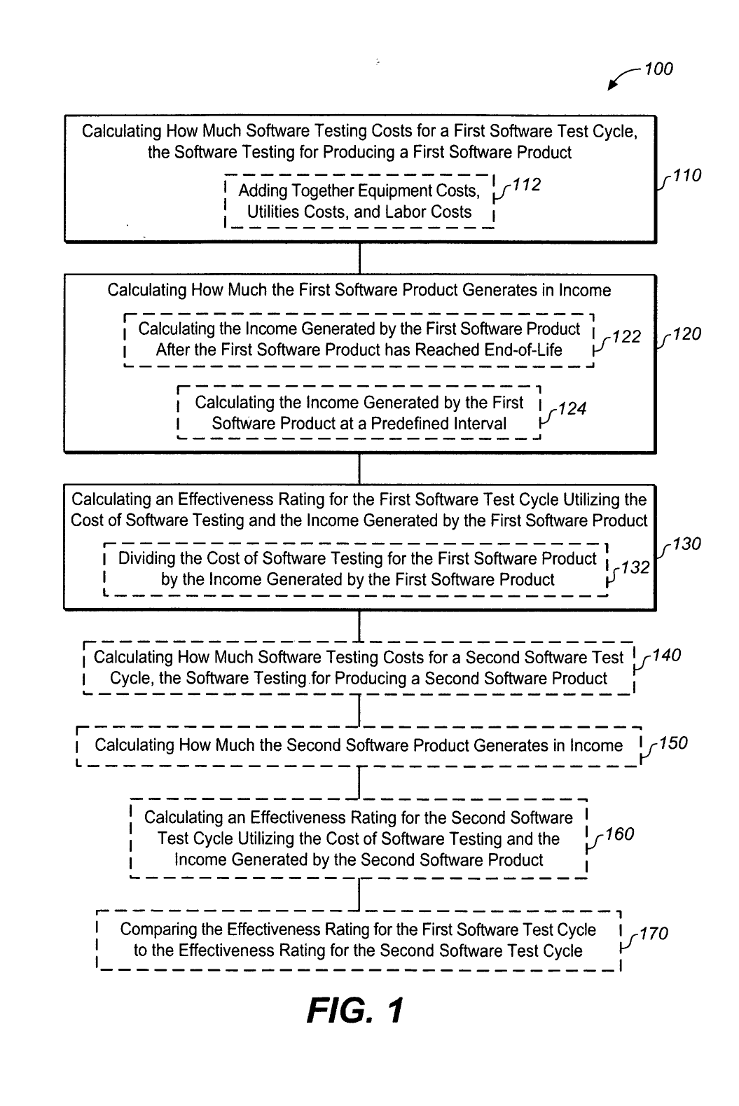

Referring now to FIG. 1, a method 100 for determining the effectiveness of a software test cycle is described in accordance with the present disclosure. Generally, a software test cycle may include transforming a first software product from an initial configuration to a final configuration. For example, the initial configuration may include one or more problems, errors, inefficiencies, outdated information, or the like, which may be corrected and/or updated in a final configuration for sale/release to the public. The method 100 may be utilized for determining the effectiveness of a first software test cycle (see FIG. 1A, steps 110-130) and the effectiveness of a second software test cycle (see FIG. 1B, steps 140-160). Then, the effectiveness of the first software test cycle may be compared to the effectiveness of the second software test cycle (see FIG. 1B, step 170). In this manner, the method 100 may be utilized for comparing software test cycle effectiveness across different cycles. Defined broadly, method 100 first calculates a cost for software testing for a particular software test cycle and then calculates an income for the resultant software product. By comparing the cost of the software testing to the income generated by the resultant software product, the method determines a value that may be utilized to represent the effectiveness of testing for that particular software test cycle.

First, the method 100 calculates a cost for software testing for a first software test cycle, 110. For example, the method may add tangible costs for software testing, such as equipment (hardware) costs (e.g., costs for servers, tables, cables, hard drives, and/or network switches), utilities costs (e.g., costs for electricity for powering and/or cooling equipment), and labor costs (e.g., employment costs for personnel tasked with the software testing), 112. It will be appreciated that the costs described above are provided by way of example only and are not meant to be restrictive of the present disclosure; other various costs may be utilized for calculating a cost for software testing for the first software test cycle.

After calculating the cost of the software testing, the method 100 calculates an income for the resultant software product, 120. In one embodiment, the income generated by the software product is calculated after the software product has reached end-of-life (i.e., when the software product no longer generates a meaningful or significant amount of revenue), 122. In other embodiments, the income generated by the software product is calculated at a predefined interval (e.g., one year after the release of the software product, two years after the release of the software product, or five years after the release of the software product), 124. In any case, when comparing the effectiveness of a first software test cycle to the effectiveness of a second software test cycle, it will be appreciated that the comparison may be most valid when the predefined interval for each test cycle is the same.

Once the cost of software testing and the income generated by the resultant software product are calculated, the method 100 calculates an effectiveness rating for the first software test cycle, 130. The effectiveness rating may be calculated utilizing the following formula:

E=T÷I,

where E is the effectiveness rating, T is the total cost of software testing, and I is the total net income generated by the resultant software product (e.g., total sales minus total expenses), 132. In one embodiment, expenses may include expenditures that could be found on a standard corporate income statement. For example, such expenditures may include expenses from categories such as “General and Administrative,” “Sales,” “Research and Development,” “Depreciation,” and/or “Testing Costs.” It should be noted that the result of this formula may be thought of as an effectiveness ratio, where smaller values or values closer to zero (i.e., as visualized on a number line) may indicate more efficient testing, and larger values or values further from zero may indicate less efficient testing.

Additionally, it will be appreciated that the total net income generated by the resultant software product could be measured in a variety of different ways. In one embodiment, the total net income generated by the resultant software product may be a measure of total sales of the product. In another embodiment, the total net income may be a measurement of gross income of the product (i.e., sales minus cost of goods). In a further embodiment, the total net income may be a measurement of the cost of supporting the product in the field. Generally, numerical amounts representing expenses and/or income for the software product may be obtained from accounting data acquired during a software test cycle. Additionally, it will be appreciated that more than one effectiveness rating may be calculated for the same test cycle. For example, a first effectiveness rating may be calculated based upon a total net income of $40,000 (e.g., $40,000 in sales) and a second effectiveness rating may be calculated for the same test cycle based upon a total net income of $20,000 (e.g., $40,000 in sales minus $20,000 in total expenses incurred during the software test cycle).

For example, the test certification for a first software test cycle (Release 10) had the following costs:
Hardware costs: $250,000,
Utilities costs: $50,000, and
Labor costs: $500,000.
   Thus, the total cost of software testing for the first software test cycle was $800,000. In this specific example, the net income generated by the resultant software product for the first software test cycle was $2,500,000. Thus, the effectiveness rating for the first software test cycle was the following:

E=T÷I,

E=($800,000+$2,500,000), and

E=0.32.

In another instance, the test certification for a second software test cycle (Release 11) had the following costs:
Hardware costs: $420,000,
Utilities costs: $80,000, and
Labor costs: $1,000,000.
   Thus, the total cost of software testing for the second software test cycle was $1,500,000. In this specific example, the net income generated by the resultant software product for the second software test cycle was $2,000,000. Thus, the effectiveness rating for the second software test cycle was the following:

E=T÷I,

E=($1,500,000÷$2,000,000), and

E=0.75.

In the two example described above, the software test cycle for Release 10 may be judged as more effective, having a lower E rating (0.32) than the software test cycle for Release 11 (0.75).

In a further example, effectiveness ratings may be calculated periodically over the course of a software test cycle. For example, a first effectiveness rating may be calculated during a first period of a test cycle, and a second effectiveness rating may be calculated during a second period of the test cycle. It will be appreciated that a period may be calculated in a variety of different ways, including periods which are discrete from one another and periods which overlap one another. In one embodiment, periods may correspond to financial quarters for a business year. Further, it will be appreciated that when the software test cycle is working in an optimal fashion (e.g., fewer bugs are detected during each part of the cycle), the resulting effectiveness ratings should decrease on a period-to-period basis.

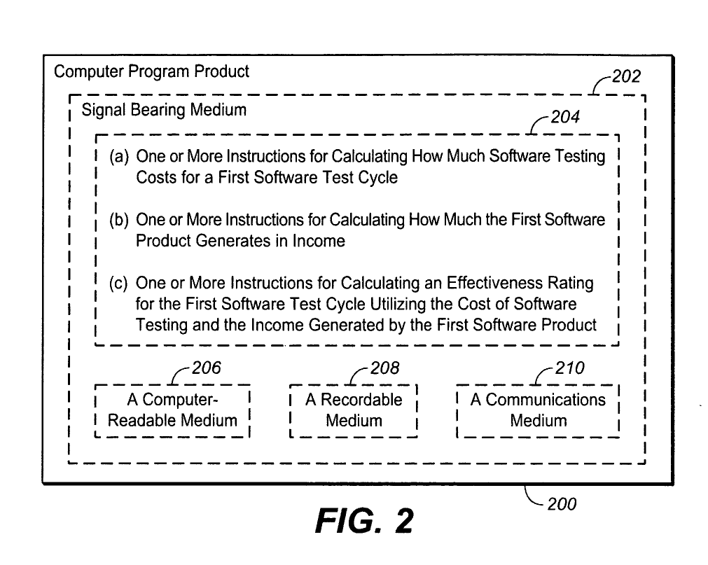

FIG. 2 illustrates a partial view of an example computer program product 200 that includes a computer program 204 for executing a computer process on a computing device. An embodiment of the example computer program product 200 is provided using a signal-bearing medium 202, and may include one or more instructions as described in FIG. 1, such as one or more instructions for calculating a cost for software testing for a first software test cycle, one or more instructions for calculating an income for the first software product, and one or more instructions for calculating an effectiveness rating for the first software test cycle utilizing the cost of software testing and the income generated by the first software product. The one or more instructions may be, for example, computer executable and/or logic-implemented instructions. In one implementation, the signal-bearing medium 202 may include a computer-readable medium 206. In one implementation, the signal bearing medium 202 may include a recordable medium 208. In one implementation, the signal bearing medium 202 may include a communications medium 210.

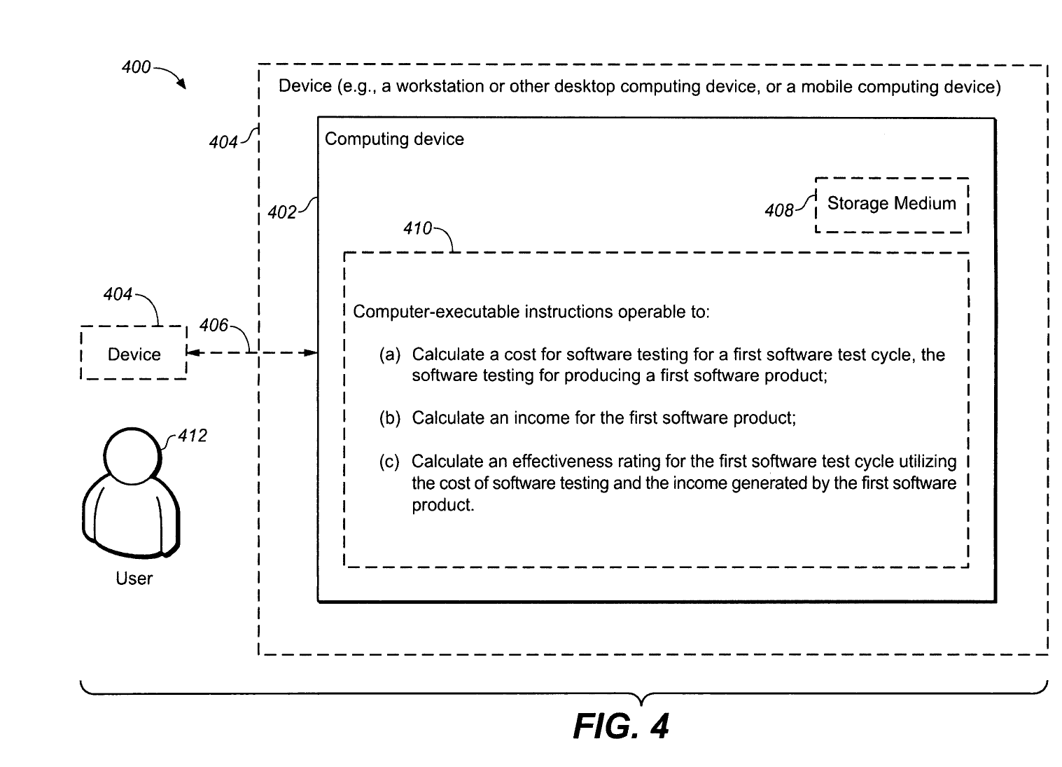

FIG. 4 illustrates an example system 400 in which embodiments may be implemented. The system 400 includes a computing system environment. The system 400 also illustrates the user 412 using a device 404, which is optionally shown as being in communication with a computing device 402 by way of an optional coupling 406. The optional coupling 406 may represent a local, wide-area, or peer-to-peer network, or may represent a bus that is internal to a computing device (e.g., in example embodiments in which the computing device 402 is contained in whole or in part within the device 404). A storage medium 408 may be any computer storage media.

The computing device 402 includes computer-executable instructions 410 that when executed on the computing device 402 cause the computing device 402 to calculate a cost for software testing for a first software test cycle, the software testing for producing a first software product, calculate an income for the first software product, and calculate an effectiveness rating for the first software test cycle utilizing the cost of software testing and the income generated by the first software product. As referenced above and as shown in FIG. 4, in some examples, the computing device 402 may optionally be contained in whole or in part within the device 404.

In FIG. 4, then, the system 400 includes at least one computing device (e.g., 402 and/or 404). The computer-executable instructions 410 may be executed on one or more of the at least one computing device. For example, the computing device 402 may implement the computer-executable instructions 410 and output a result to (and/or receive data from) the computing device 404. Since the computing device 402 may be wholly or partially contained within the computing device 404, the device 404 also may be said to execute some or all of the computer-executable instructions 410, in order to be caused to perform or implement, for example, various ones of the techniques described herein, or other techniques.

The device 404 may include, for example, a portable computing device, workstation, or desktop computing device. In another example embodiment, the computing device 402 is operable to communicate with the device 404 associated with the user 412 to receive information about the input from the user 412 for performing data access and data processing and presenting an output of the software test cycle effectiveness function at least partly based on the user data.

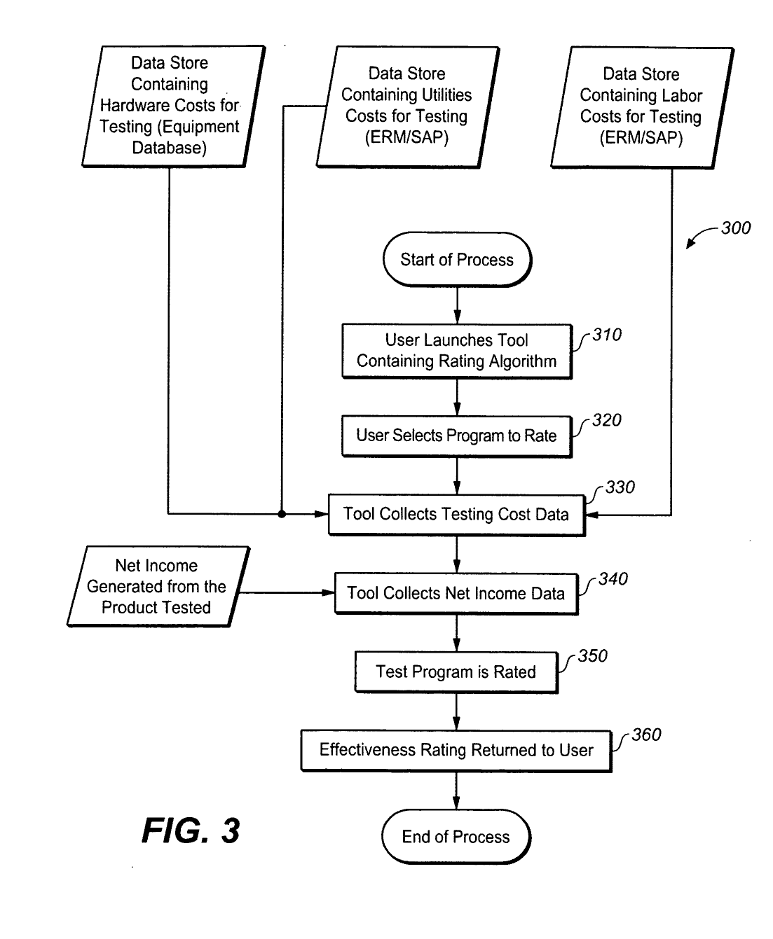

FIG. 3 illustrates a method 300 describing how a user may utilize the computer program product 200 illustrated in FIG. 2. For example, the user may launch the computer program product (tool), 310. Next, the user may select one or more programs to rate, 320. The tool may then collect testing cost data, 330 and net income data, 340 (as previously described). Next, the test program may be rated, 350. And finally, the effectiveness rating may be returned to the user, 360.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method, comprising:
calculating a cost for software testing for a first software test cycle, the software testing for producing a first software product;
calculating an income for the first software product; and
calculating an effectiveness rating for the first software test cycle utilizing the cost of software testing and the income generated by the first software product.

2. The method of claim 1, wherein calculating a cost for software testing for a first software test cycle comprises summing equipments costs, utilities costs, and labor costs.

3. The method of claim 1, wherein calculating an income for the first software product comprises calculating the income generated by the first software product after the first software product has reached end-of-life.

4. The method of claim 1, wherein calculating an income for the first software product comprises calculating the income generated by the first software product at a predefined interval.

5. The method of claim 1, wherein calculating an effectiveness rating for the first software test cycle utilizing the cost of software testing and the income generated by the first software product comprises dividing the cost of software testing for the first software product by the income generated by the first software product.

6. The method of claim 1, further comprising:
calculating a cost for software testing for a second software test cycle, the software testing for producing a second software product;
calculating an income for the second software product; and
calculating an effectiveness rating for the second software test cycle utilizing the cost of software testing and the income generated by the second software product.

7. The method of claim 6, further comprising comparing the effectiveness rating for the first software test cycle to the effectiveness rating for the second software test cycle.

8. A computer program product, comprising:
a signal bearing medium bearing
one or more instructions for calculating a cost for software testing for a first software test cycle, the software testing for producing a first software product;
one or more instructions for calculating an income for the first software product; and
one or more instructions for calculating an effectiveness rating for the first software test cycle utilizing the cost of software testing and the income generated by the first software product.

9. The computer program product of claim 8, wherein calculating a cost for software testing for a first software test cycle comprises summing equipments costs, utilities costs, and labor costs.

10. The computer program product of claim 8, wherein calculating an income for the first software product comprises calculating the income generated by the first software product after the first software product has reached end-of-life.

11. The computer program product of claim 8, wherein calculating an income for the first software product comprises calculating the income generated by the first software product at a predefined interval.

12. The computer program product of claim 8, wherein calculating an effectiveness rating for the first software test cycle utilizing the cost of software testing and the income generated by the first software product comprises dividing the cost of software testing for the first software product by the income generated by the first software product.

13. The computer program product of claim 8, further comprising:
one or more instructions for calculating a cost for software testing for a second software test cycle, the software testing for producing a second software product;
one or more instructions for calculating an income for the second software product; and
one or more instructions for calculating an effectiveness rating for the second software test cycle utilizing the cost of software testing and the income generated by the second software product.

14. The computer program product of claim 13, further comprising one or more instructions for comparing the effectiveness rating for the first software test cycle to the effectiveness rating for the second software test cycle.

15. A method, comprising:
transforming a first software product from an initial configuration to a final configuration during a first software test cycle;
calculating a cost for software testing for the first software test cycle;
calculating an income for the first software product; and
calculating an effectiveness rating for the first software test cycle utilizing the cost of software testing and the income generated by the first software product.

16. The method of claim 1, wherein calculating a cost for software testing for the first software test cycle comprises summing equipments costs, utilities costs, and labor costs.

17. The method of claim 1, wherein calculating an income for the first software product comprises calculating the income generated by the first software product after the first software product has reached end-of-life.

18. The method of claim 1, wherein calculating an income for the first software product comprises calculating the income generated by the first software product at a predefined interval.

19. The method of claim 1, wherein calculating an effectiveness rating for the first software test cycle utilizing the cost of software testing and the income generated by the first software product comprises dividing the cost of software testing for the first software product by the income generated by the first software product.

20. The method of claim 1, further comprising:
transforming a second software product from an initial configuration to a final configuration during a second software test cycle;
calculating a cost for software testing for the second software test cycle;
calculating an income for the second software product; and
calculating an effectiveness rating for the second software test cycle utilizing the cost of software testing and the income generated by the second software product.
